(19) United States
(12) Patent Application Publication
(10) Pub. No.: US 2026/0280791 A1
(43) Pub. Date: Sep. 17, 2026

(54) SUBBAND CONFIGURATION

(71) Applicant: ZTE Corporation, Shenzhen (CN)

(72) Inventors: Xingguang WEI, Shenzhen (CN); Xing LIU, Shenzhen (CN); Shuaihua KOU, Shenzhen (CN); Wei GOU, Shenzhen (CN); Xianghui HAN, Shenzhen (CN); Jing SHI, Shenzhen (CN)

(73) Assignee: ZTE Corporation, Shenzhen, GD (CN)

(21) Appl. No.: 19/669,392

(22) Filed: May 6, 2026

Related U.S. Application Data
(63) Continuation of application No. PCT/CN2023/131043, filed on Nov. 10, 2023.

(51) Int. Cl. H04L 5/00; H04L 27/26

(52) U.S. Cl. CPC H04L 5/0044; H04L 5/0098; H04L 27/26025

(57) ABSTRACT

A method includes a base station indicating to a UE at least one frequency resource for at least one subband, wherein the at least one subband comprises at least one of a Downlink (DL) subband, an Uplink (UL) subband, or a guard band.

### TECHNICAL FIELD

This disclosure generally relates to handling transmissions in a wireless cellular access network and is specifically directed to mechanisms for configuring subbands for full duplex.

### BACKGROUND

Subband full duplex (SBFD) systems, or in-band full duplex system (IBFD) are typical full duplex systems. For a SBFD system, downlink (DL) transmission and uplink (UL) transmission do not occur at the same time-domain and frequency-domain resources. While for IBFD systems, DL transmission and UL transmission can occur at the same time-domain and frequency-domain resources. For full duplex systems, subband is commonly applied to configure the frequency resources for DL transmission, UL transmission, or guard band. Overall, there are three typical subbands. For DL subband, resources can be used for DL transmission; for UL subband, resources can be used for UL transmission; and for Guard band, resources can't be used for either DL transmission or UL transmission. The guard band is used to suppress the cross link interference (CLI), e.g., interference from DL to UL in the same orthogonal frequency division multiplexing (OFDM) symbol.

A detailed method to configure DL subband, UL subband, and guard band does not exist in terms of the subband size, reference point for the frequency resource configuration, subcarrier spacing, and configuration overhead reduction.

### SUMMARY

This disclosure generally relates to handling transmissions in a wireless cellular access network and is specifically directed to mechanisms for configuring subbands for full duplex.

In some exemplary implementations, a method performed by a wireless access network node (WANN) includes indicating, to a wireless terminal device (e.g., UE), at least one frequency resource for at least one subband, wherein the at least one subband comprises at least one of a Downlink (DL) subband, an Uplink (UL) subband, or a guard band. Similarly, a method performed by the wireless terminal device includes receiving, from a WANN, an indication of at least one frequency resource for at least one subband, wherein the at least one subband comprises at least one of a Downlink (DL) subband, an Uplink (UL) subband, or a guard band. The methods may further include the WANN indicating or the UE receiving an indication of a starting point and a subband bandwidth of the at least one subband, a middle point and a subband bandwidth of the at least one subband, a middle point and half of a subband bandwidth of the at least one subband, or a subband bandwidth of the at least one subband. The subband bandwidth may correspond to a number of frequency units for the subband.

In some exemplary implementations, which may be combined with any of the other exemplary implementations disclosed herein, the method includes the WANN indicating, and the UE receiving an indication of the starting point or the middle point of the UL subband as a frequency offset relative to a reference point. The reference point may be one of the following: point A, where point A serves as a common reference point for resource block grids; a starting point of a DL bandwidth part (BWP) that is associated with the UL subband; a starting point of a DL carrier that corresponds to subcarrier spacing of a DL BWP that is associated with the UL subband; a starting point of an UL BWP that is associated with the UL subband; a starting point of an UL carrier that corresponds to subcarrier spacing of an UL BWP that is associated with the UL subband; a lowest starting point of an UL carrier corresponding to all configured subcarrier spacings of the UL carrier; a lowest starting point of a DL carrier corresponding to all configured subcarrier spacings of the DL carrier; or a lowest starting point selected from the lowest starting point of the DL carrier corresponding to all the configured subcarrier spacings of the DL carrier and the lowest starting point of the UL carrier corresponding to all the configured subcarrier spacings of the UL carrier.

In some exemplary implementations, which may be combined with any of the other exemplary implementations disclosed herein, the method includes the WANN indicating, and the UE receiving an indication of the frequency offset as a first subcarrier spacing S1, and/or the subband bandwidth of the UL subband as a second subcarrier spacing S2. S1 and/or S2 may be one of the following alternatives: a subcarrier spacing of the DL BWP that is associated with the UL subband; a subcarrier spacing of the UL BWP that is associated with the UL subband; a smallest subcarrier spacing of all the UL BWPs for the UL carrier; a smallest subcarrier spacing of all the DL BWPs for the DL carrier; a largest subcarrier spacing of all the UL BWPs for the UL carrier; a largest subcarrier spacing of all the DL BWPs for the DL carrier; a smallest subcarrier spacing configured for the UL carrier; a smallest subcarrier spacing configured for the DL carrier; a smallest subcarrier spacing of all the UL BWPs for the UL carrier and all the DL BWPs for the DL carrier; a smallest subcarrier spacing configured for the UL carrier and DL carrier; a smallest subcarrier spacing allowed for each frequency range; or a largest subcarrier spacing allowed for each frequency range.

In some exemplary implementations, which may be combined with any of the other exemplary implementations disclosed herein, the method includes the WANN indicating, and the UE receiving an indication of a starting point or the middle point of the DL subband as a frequency offset relative to a reference point. The reference point may one of the following: point A, where point A serves as a common reference point for resource block grids; a starting point of a DL bandwidth part (BWP) that is associated with the DL subband; a starting point of a DL carrier that corresponds to subcarrier spacing of a DL BWP that is associated with the DL subband; a starting point of an UL BWP that is associated with the DL subband; a starting point of an UL carrier that corresponds to subcarrier spacing of an UL BWP that is associated with the DL subband; a lowest starting point of an UL carrier corresponding to all configured subcarrier spacings of the UL carrier; a lowest starting point of a DL carrier corresponding to all configured subcarrier spacings of the DL carrier; or a lowest starting point selected from the lowest starting point of the DL carrier corresponding to all the configured subcarrier spacings of the DL carrier or the lowest starting point of the UL carrier corresponding to all the configured subcarrier spacings of the UL carrier.

In some exemplary implementations, which may be combined with any of the other exemplary implementations disclosed herein, the method includes the WANN indicating, and the UE receiving an indication of the frequency offset as a first subcarrier spacing S1, and/or the subband bandwidth of the UL subband as a second subcarrier spacing S2. S1 and/or S2 may be one of the following alternatives: a subcarrier spacing of the DL BWP that is associated with the DL subband; a subcarrier spacing of the UL BWP that is associated with the DL subband; a smallest subcarrier spacing of all the UL BWPs for the UL carrier; a smallest subcarrier spacing of all the DL BWPs for the DL carrier; a largest subcarrier spacing of all the UL BWPs for the UL carrier; a largest subcarrier spacing of all the DL BWPs for the DL carrier; a smallest subcarrier spacing configured for the UL carrier; a smallest subcarrier spacing configured for the DL carrier; a smallest subcarrier spacing of all the UL BWPs for the UL carrier and all the DL BWPs for the DL carrier; a smallest subcarrier spacing configured for the UL carrier and DL carrier; a smallest subcarrier spacing allowed for each frequency range; or a largest subcarrier spacing allowed for each frequency range.

In some exemplary implementations, which may be combined with any of the other exemplary implementations disclosed herein, the method includes the WANN indicating, and the UE receiving an indication of an Uplink-Downlink (UD) subband pattern, a Downlink-Uplink (DU) subband pattern, or a Downlink-Uplink-Downlink (DUD) subband pattern. The subband pattern may be indicated by Radio Resource Control (RRC) signaling, by indicating a same middle point for the UL subband and a DL BWP for a DUD pattern, by indicating a same starting point for the UL subband and a DL BWP for a DU pattern, or by indicating a same starting point for the DL subband and a DL BWP for a UD pattern.

In some exemplary implementations, which may be combined with any of the other exemplary implementations disclosed herein, the method includes the WANN indicating, and the UE receiving an indication of the DUD subband pattern and a DL subband bandwidth (B_{DL-subband}), wherein a starting point of a first DL subband is a starting point of the DL BWP (S_{DL-BWP}), and an ending point of the first DL subband is S_{DL-BWP}+B_{DL-subband}; and wherein an ending point of a second DL subband is an ending point of the DL BWP (E_{DL-BWP}), and a starting point of the second DL subband is E_{DL-BWP}−B_{DL-subband}. The method may include the WANN indicating, and the UE receiving an indication of the DUD subband pattern and an UL subband bandwidth (B_{UL-subband}), wherein a middle point of the UL subband is a middle point of the DL BWP (M_{DL-BWP}), wherein a starting point of the UL subband is M_{DL-BWP}−B_{UL-subband}/2, and where an ending point of the UL subband is M_{DL-BWP}+B_{UL-subband}/2. The UE may also determine these points.

In some exemplary implementations, which may be combined with any of the other exemplary implementations disclosed herein, the method includes the WANN indicating, and the UE receiving an indication of the DU or UD subband patterns, wherein the starting point of the DL subband is S_{DL-BWP}, wherein an ending point of the DL subband is S_{DL-BWP}+B_{DL-subband}, wherein the starting point of the UL subband is E_{DL-BWP}, and wherein an ending point of the UL subband is E_{DL-BWP}−B_{UL-subband}. The method may include the WANN indicating, and the UE receiving an indication of the DU or UD subband patterns, wherein the starting point of the UL subband is S_{DL-BWP}, wherein an ending point of the UL subband is S_{DL-BWP}+B_{UL-subband}, wherein the starting point of the DL subband is E_{DL-BWP}, and wherein an ending point of the DL subband is E_{DL-BWP}−B_{DL-subband}. The UE may also determine these points.

In some exemplary implementations, which may be combined with any of the other exemplary implementations disclosed herein, the method includes the WANN indicating, and the UE receiving an indication of the DU or UD subband patterns, a bandwidth of a guard band (B_{Guard}), and a bandwidth of the UL subband (B_{UL-subband}), wherein, for the UD subband pattern, a starting point of the DL subband is aligned with a starting point of the DL BWP (S_{DL-BWP}), and an ending point of the DL subband is E_{DL-BWP}−B_{UL-subband}−B_{Guard}, and wherein, for the DU subband pattern, the starting point of the DL subband is S_{DL-BWP}+B_{UL-subband}+B_{Guard}, and the ending point of the DL subband is aligned with the ending point of the DL BWP (E_{DL-BWP}). Similarly, the method may include the WANN indicating, and the UE receiving an indication of the DU or UD subband patterns, a bandwidth of a guard band (B_{Guard}), and a bandwidth of the DL subband (B_{DL-subband}), wherein, for the DU subband pattern, a starting point of the UL subband is aligned with a starting point of the DL BWP (S_{DL-BWP}), and an ending point of the UL subband is E_{DL-BWP}−B_{DL-subband}−B_{Guard}, and wherein, for the UD subband pattern, the starting point of the UL subband is S_{DL-BWP}+B_{DL-subband}+B_{Guard}, and the ending point of the UL subband is aligned with the ending point of the DL BWP (E_{DL-BWP}). The UE may also determine these points.

In some exemplary implementations, which may be combined with any of the other exemplary implementations disclosed herein, the method includes the WANN indicating, and the UE receiving an indication of the DUD subband pattern, a bandwidth of a guard band (B_{Guard}), and a bandwidth of the DL subband (B_{DL-subband}), wherein a starting point of a first guard band is S_{DL-BWP}+B_{DL-subband}, and an ending point of the first guard band is S_{DL-BWP}+B_{DL-subband}+B_{Guard}, and wherein a starting point of a second guard band is E_{DL-BWP}−B_{DL-subband}−B_{Guard}, and an ending point of the second guard band is E_{DL-BWP}−B_{DL-subband}. Similarly, the method may include the WANN indicating, and the UE receiving an indication of the DU or UD subband patterns, a bandwidth of a guard band (B_{Guard}), and a bandwidth of the DL subband (B_{DL-subband}), wherein, for the UD subband pattern, a starting point of the guard band is S_{DL-BWP}+B_{DL-subband}, and an ending point of the guard band is S_{DL-BWP}+B_{DL-subband}+B_{Guard}, and wherein, for the DU subband pattern, the starting point of the guard band is S_{DL-BWP}+B_{UL-subband}, and the ending point of the guard band is S_{DL-BWP}+B_{UL-subband}+B_{Guard}. The UE may also determine these points.

In some exemplary implementations, which may be combined with any of the other exemplary implementations disclosed herein, a bandwidth of the guard band corresponds to a subcarrier spacing S, wherein the subcarrier spacing S is determined as one of the following: S is the same as a subcarrier spacing of the DL subband; S is the same as a subcarrier spacing of the UL subband; S is a smaller one of the subcarrier spacing of the DL subband and the subcarrier spacing of the UL subband; or S is a larger one of the subcarrier spacing of the DL subband and the subcarrier spacing of the UL subband. In some embodiments, a frequency resource of the UL subband is within the DL BWP that is associated with the UL subband, and is within an UL BWP that is associated with the DL BWP.

In some exemplary implementations, which may be combined with any of the other exemplary implementations disclosed herein, DL BWP may be associated with the DL subband in response to at least one of the following being satisfied: a frequency resource of the DL subband is within the DL BWP; a starting point of the DL subband is aligned with a starting point of the DL BWP or aligned with an ending point of the DL BWP; or an ending point of the DL subband is aligned with the ending point of the DL BWP. The UL BWP may be associated with the UL subband in response to at least one of the following being satisfied: a frequency resource of the UL subband is within the UL BWP; a starting point of the UL subband is aligned with a starting point of the UL BWP or aligned with an ending point of the UL BWP; an ending point of the UL subband is aligned with the ending point of the UL BWP; or a middle point of the UL subband is aligned with a middle point of the UL BWP. The DL BWP may be associated with the UL subband in response to at least one of the following being satisfied: a frequency resource of the UL subband is within the DL BWP; a starting point of the UL subband is aligned with a starting point of the UL BWP or aligned with an ending point of the UL BWP; an ending point of the UL subband is aligned with an ending point of the DL BWP; or a middle point of the UL subband is aligned with a middle point of the DL BWP. The UL BWP may be associated with the DL subband in response to at least one of the following being satisfied: a frequency resource of the DL subband is within the UL BWP; a starting point of the DL subband is aligned with a starting point of the UL BWP or aligned with an ending point of the UL BWP; an ending point of the DL subband is aligned with an ending point of the UL BWP; or a middle point of the DL subband is aligned with a middle point of the UL BWP.

In some other implementations, an apparatus for wireless communication such as a network device is disclosed. The network device may include one or more processors and one or more memories, wherein the one or more processors are configured to read computer code from the one or more memories to implement any one of the methods above. The apparatus for wireless communication may be the wireless access network node (e.g., base station) or the wireless terminal device (e.g., UE).

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with an exemplary uplink, downlink, and control channel configuration.

FIG. 2 shows various example processing components of the wireless terminal device and the wireless access network node of FIG. 1.

FIG. 3 shows example subband patterns in accordance with various embodiments.

FIG. 4 shows an example a subband in accordance with various embodiments.

FIG. 5 shows another example of a subband pattern in accordance with various embodiments.

FIG. 6 shows an example of subband bandwidths in accordance with various embodiments.

### DETAILED DESCRIPTION

The technology and examples of implementations and/or embodiments described in this disclosure can be used to facilitate over-the-air radio resource allocation, configuration, and signaling in wireless access networks as well as operational configuration of a UE and/or a base station within the wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to handling transmissions in a wireless cellular access network and is specifically directed to mechanisms for configuring subbands for full duplex.

### Wireless Network Overview

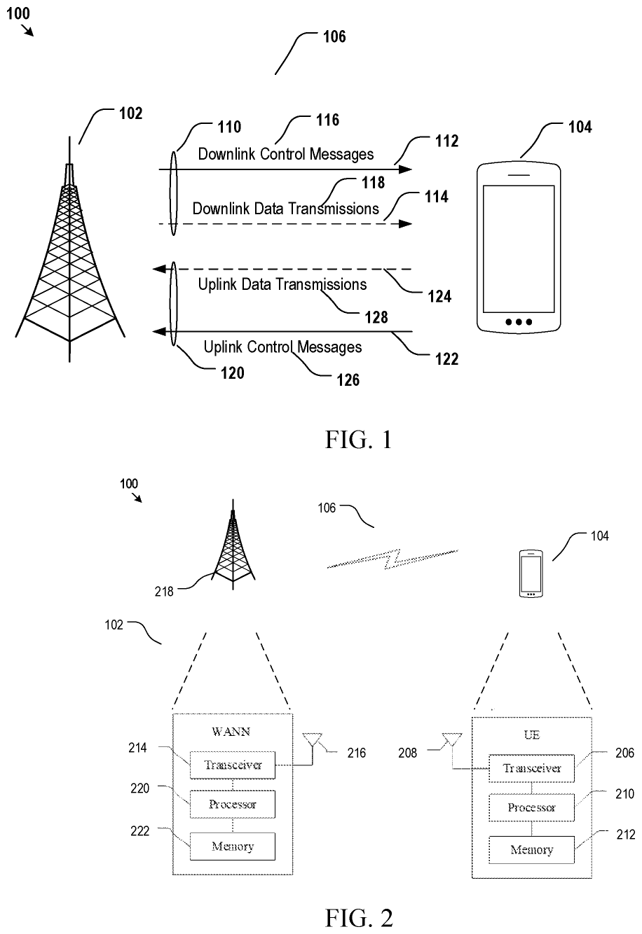

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes of the UE 104 described herein. The memory 212 may also be utilized and allocated for buffering UL and DL transmissions in each band/carrier. The memory 212 may include multiple memory modules assigned to different functions (such as program memory, base band memory, and/or RF memory, to name a few). Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Wireless Communication Resource Scheduling/Signaling

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink channels 110 for transmitting wireless signals from the base station 102 to the user equipment 104 and physical uplink channels 120 for transmitting wireless signals from the user equipment 104 to the base station 102. The physical downlink channels 110 may further include physical downlink control channels (PDCCHs) 112 and physical downlink shared channels (PDSCHs) 114. Likewise, the physical uplink channels 120 may further include physical uplink control channels (PUCCHs) 122 and physical uplink shared channels (PUSCHs) 124. For simplification, other types of downlink and uplink channels are not shown in FIG. 1 but are within the scope of the current disclosure. The control channels PDCCHs 112 and PUCCHs 122 may be used for carrying control information in the form of control messages 116 and 126, herein referred to as Downlink Control Information (DCI) messages or Uplink Control Information (UCI) messages. The shared channels (shared between data and control information) PDSCHs 114 and PUSCHs 124 may be allocated and used for communicating downlink data transmissions 118 and uplink data transmissions 128 between the base station 102 and the user equipment 104.

The allocation and configuration of the radio communication resources associated with the data channels, such as the PDSCHs and the PUSCHs may be provided by one or more resource scheduling DCIs carried in the PDCCHs. The PDCCHs may be shared by a plurality of UEs in the access network. In various approaches, a particular UE may be configured to perform blind decode procedures on a preconfigured UE-specific Search Space (USS) to detect and identify a payload of a resource scheduling DCI carried in the PDCCH that specifically targets the particular UE. The blind decoding may be performed on preconfigured monitoring occasions of the PDCCH associated with USS. Such monitoring occasions may be referred to as a set of PDCCH candidates. Each PDCCH candidate may be associated with a set of Control Channel Elements (CCEs). The UE may specifically use its Radio Network Temporary Identifier (RNTI) to decode the PDCCH candidates. The RNTI may be used to demask a PDCCH candidate's CRC. If no CRC error is detected, the UE determines that PDCCH candidate carries its own control information. The UE may then process the DCI and extract the resource allocation information pertaining to the PDSCH and/or PUSCH for receiving and/or transmitting data.

### Example Subband Patterns

In the present 5G systems, each cell may contain one DL carrier and zero, one, or two UL carriers. Each DL carrier can be configured with one or multiple DL bandwidth parts (BWP) with the same or different bandwidths with the same or different subcarrier spacing. Similarly, each UL carrier can be configured with one or multiple UL BWPs with the same or different bandwidths with the same or different subcarrier spacing. Each BWP is configured with an index. In Time Division Duplex (TDD) systems, the DL BWP and UL BWP with the same index are considered as a BWP pair. The DL BWP and UL BWP in the BWP pair are configured with the same center frequency. In other words, the middle point of the DL BWP and UL BWP in the BWP pair are aligned.

For one carrier (e.g., DL carrier or UL carrier), different frequency resources can be configured for different subcarrier spacing, that is, different carrier bandwidths or different starting points. The starting point for one carrier refers to the lowest usable subcarrier on this carrier for a certain subcarrier spacing.

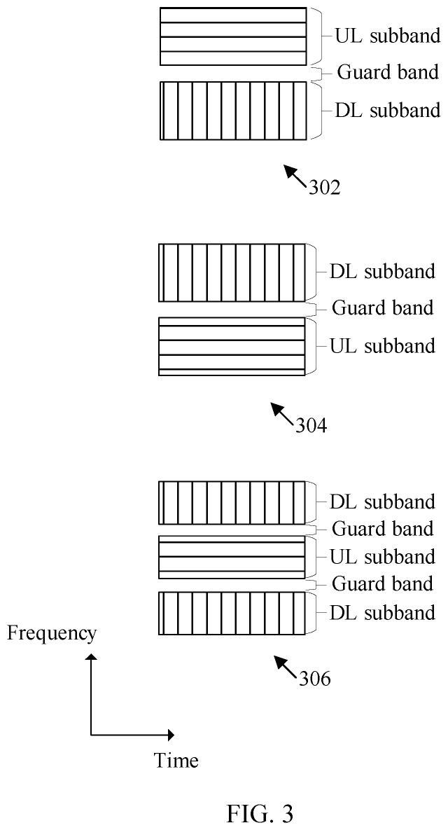

As shown in FIG. 3, three different typical subband patters can be applied. In a first example subband pattern 302, a guard band is within the UL subband and DL subband, where the UL subband is located at higher frequency and the DL subabnd is located at lower frequency. This is called an uplink-downlink subband pattern or a “UD” subband pattern. In a second example subband pattern 304, a guard band is within the UL subband and DL subband, where the DL subband is located at a higher frequency and the UL subabnd is located at a lower frequency. This is called a downlink-uplink subband pattern or a “DU” subband pattern. In a third example subband pattern 306, there are two DL subbands and one UL subband in between the two DL subbands, and there is one guard band at each side of the UL subband. This is called an downlink-uplink-downlink subband pattern or a “DUD” subband pattern. In some cases, a base station can also configure an uplink-downlink-uplink subband pattern (UDU), where there are two UL subbands and one DL subband in between the two UL subbands, in a similar though opposite manner to the third example subband pattern 306.

### Description of New Mechanisms for Subband Configuration

In accordance with the present disclosure, methods are disclosed to configure and/or indicate frequency resources for one or more subbands, for example, in a full duplex system. In various embodiments, the frequency resources of the subband(s) can be configured by the base station 102 configuring the starting point and the subband bandwidth of one or more subbands. In another example, the base station 102 may configure the middle point and the subband bandwidth of one or more subbands. In another example, the base station 102 may configure the middle point and half of the subband bandwidth of one or more subbands. In another example, the base station 102 may configure the subband bandwidth. The one or more subbands can be a DL subband, and UL subband, or a guard band.

In accordance with various embodiments, a method performed by a WANN 102 (e.g., wireless base station 102) includes indicating, to a wireless terminal device 104 (e.g., UE 104), at least one frequency resource for at least one subband, wherein the at least one subband comprises at least one of a Downlink (DL) subband, an Uplink (UL) subband, or a guard band. The method may further include the WANN 102 indicating, to the wireless terminal device 104, a starting point and a subband bandwidth of the at least one subband. The method may further include the WANN 102 indicating, to the wireless terminal device 104, a middle point and a subband bandwidth of the at least one subband. The method may further include the WANN 102 indicating, to the wireless terminal device 104, a middle point and half of a subband bandwidth of the at least one subband. The method may further include the WANN 102 indicating, to the wireless terminal device, a subband bandwidth of the at least one subband.

Similarly, a method performed by the wireless terminal device 104 (e.g., UE 104) includes receiving, from a wireless access network node 102, an indication of at least one frequency resource for at least one subband, wherein the at least one subband comprises at least one of a Downlink (DL) subband, an Uplink (UL) subband, or a guard band. The method may further include the wireless terminal device 104 receiving, from the wireless access network node 102, an indication of a starting point and a subband bandwidth of the at least one subband. The method may further include the wireless terminal device 104 receiving, from the wireless access network node 102, an indication of a middle point and a subband bandwidth of the at least one subband. The method may further include the wireless terminal device 104 receiving, from the wireless access network node 102, an indication of a middle point and half of a subband bandwidth of the at least one subband. The method may further include the wireless terminal device 104 receiving, from the wireless access network node 102, an indication of a subband bandwidth of the at least one subband.

It should be understood that the present disclosure uses the terms “configure” and “indicate” interchangeably and are intended to encompass the same concepts (e.g., the base station 102 may configure a subband frequency resource to a UE 104 or indicate the subband frequency resource to a UE 104).

In certain approaches, the subband bandwidth may correspond to a number of frequency units for the subband. The frequency unit can be resource element (RE), resource block (RB), a resource block group (RBG), etc., where RB is the most commonly used frequency unit. For example, if the subband bandwidth for DL subband is 10 RBs, then there are 10 RBs for the DL subband.

The starting point or starting point of a subband may correspond to the first frequency unit for the subband. For example, the starting point of the subband may correspond to the first RB for the subband. The starting point of the DL BWP may correspond to the first frequency unit for the DL BWP. The starting point of the UL BWP may correspond to the first frequency unit for the UL BWP. The starting point of the DL carrier may correspond to the first frequency unit for the DL carrier. The starting point of the UL carrier may correspond to the first frequency unit for the UL carrier.

The middle point of the subband may correspond to the middle frequency unit for the subband. Assuming the number of the frequency units for the subband is M, i.e., the bandwidth of the subband is M frequency units. If M is an odd number, then the middle point of the subband is the (M/2)th frequency unit. If M is even number, then the middle point of the subband is the (M/2)th or the (M/2+1)th frequency unit. For example, if the bandwidth of the subband is 5 RBs, then the middle point of the subband may be the 3rd RB of the subband. Similarly, if the bandwidth of the subband is 48 REs (i.e., 4 RBs), then the middle point of the subband may be the 24th or 25th RE.

The middle point of the DL BWP may correspond to the middle frequency unit for the DL BWP. The middle point of the UL BWP may correspond to the middle frequency unit for the UL BWP. The middle point of the DL carrier may correspond to the middle frequency unit for the DL carrier. The middle point of the UL carrier may correspond to the middle frequency unit for the UL carrier.

In embodiments where the base station 102 indicates a subband bandwidth of the subband, the base station 102 may not need to configure a starting point or middle point of the subband explicitly to the UE 104. Instead, the starting point of the subband is determined, e.g., by the UE, in accordance with embodiments disclosed further below.

### Configuration of Frequency Resources for UL Subband

In accordance with various embodiments, the starting point or middle point of the UL subband may be configured as a frequency offset relative to a reference point. As such, the method may include the base station 102 indicating, to the wireless terminal device 104, and the wireless terminal device 104 receiving an indication of the starting point or the middle point of the UL subband as a frequency offset relative to a reference point.

The reference point may be defined as one of the following alternatives. The reference point may be point A, where point A serves as a common reference point for resource block grids. Point A is defined in the 3GPP specification TS 38.211. Point A is the same reference point for both DL and UL in TDD systems, which may be convenient to determine the frequency resource for both DL subband and UL subband.

The reference point may be the starting point of the DL BWP that is associated with the UL subband. The UL subband may be configured in the DL BWP, and thus it may be convenient to configure the UL subband within the DL BWP via this alternative.

The reference point may be the starting point of the DL carrier that corresponds to the subcarrier spacing of the DL BWP that is associated with the UL subband. The UL subband may be configured in the DL BWP, and the starting point of the DL carrier for a certain subcarrier spacing may be common for all the DL BWPs with the same subcarrier spacing. Thus, it may be convenient to configure the same frequency resources for the UL subband for all the DL BWPs with the same subcarrier spacing.

The reference point may be the starting point of the UL BWP that is associated with the UL subband. It may be convenient to configure the UL subband within the UL BWP.

The reference point may be the starting point of the UL carrier that corresponds to the subcarrier spacing of the UL BWP that is associated with the UL subband. It may be convenient to configure the UL subband within the UL BWP and also within the UL carrier.

The reference point may be the lowest starting point of the UL carrier corresponding to all the configured subcarrier spacings of this UL carrier. It may be convenient to configure the same frequency resource for the UL subband for UL carrier for different subcarrier spacings.

The reference point may be the lowest starting point of the DL carrier corresponding to all the configured subcarrier spacings of this DL carrier. It may be convenient to configure the same frequency resource for the UL subband for DL carrier for different subcarrier spacings.

The reference point may be the lowest starting point selected from the lowest starting point of the DL carrier corresponding to all the configured subcarrier spacings of this DL carrier and the lowest starting point of the UL carrier corresponding to all the configured subcarrier spacings of this UL carrier. It may be convenient to configure the same frequency resource for the UL subband for both DL carrier and UL carrier for different subcarrier spacings.

As stated above, the starting point or middle point of the UL subband may be configured as a frequency offset relative to a reference point. The subband bandwidth (or half of the subband bandwidth) may be configured as a number of the frequency units. The frequency offset for configuring the starting point or middle point of the UL subband may correspond to a subcarrier spacing S1. The subband bandwidth for the UL subband may correspond to a subcarrier spacing S2. The subcarrier spacing S1 can be the same as or different from the subcarrier spacing S2. As such, the method may include the base station 102 indicating to the UE 104, and the UE 104 receiving an indication of the frequency offset as a first subcarrier spacing S1, and/or the subband bandwidth of the UL subband as a second subcarrier spacing S2. The method may also include the base station 102 indicating to the UE 104, and the UE 104 receiving an indication of the first subcarrier spacing S1 and the second subcarrier spacing S2 according to one of the following alternatives.

The subcarrier spacing S1 or S2 may be the subcarrier spacing of the DL BWP that is associated with the UL subband. In this approach, it may be convenient to guarantee that the frequency resource of UL subband is within the associated DL BWP.

The subcarrier spacing S1 or S2 may be the subcarrier spacing of the UL BWP that is associated with the UL subband. In this approach, it may be convenient to guarantee that the frequency resource of UL subband is within the associated UL BWP.

The subcarrier spacing S1 or S2 may be the smallest subcarrier spacing of all the UL BWPs for the UL carrier. In this approach, it may be convenient to configure the same frequency resource of the UL subband for all the UL BWPs.

The subcarrier spacing S1 or S2 may be the smallest subcarrier spacing of all the DL BWPs for the DL carrier. In this approach, it may be convenient to configure the same frequency resource of the UL subband for all the DL BWPs.

The subcarrier spacing S1 or S2 may be the largest subcarrier spacing of all the UL BWPs for the UL carrier. In this approach, it may be convenient to configure the same frequency resource of the UL subband for all the UL BWPs.

The subcarrier spacing S1 or S2 may be the largest subcarrier spacing of all the DL BWPs for the DL carrier. In this approach, it may be convenient to configure the same frequency resource of the UL subband for all the DL BWPs.

The subcarrier spacing S1 or S2 may be the smallest subcarrier spacing configured for the UL carrier. In this approach, it may be convenient to configure the same frequency resource of the UL subband for all the UL BWPs.

The subcarrier spacing S1 or S2 may be the smallest subcarrier spacing configured for the DL carrier. In this approach, it may be convenient to configure the same frequency resource of the UL subband for all the DL BWPs.

The subcarrier spacing S1 or S2 may be the smallest subcarrier spacing of all the UL BWPs for the UL carrier and all the DL BWPs for the DL carrier. Alternatively, the subcarrier spacing S1 or S2 may be the smallest subcarrier spacing configured for the UL carrier and DL carrier. In these approaches, it may be convenient to configure the same frequency resource of UL subband for all the DL BWPs and for all the UL BWPs.

The subcarrier spacing S1 or S2 may be smallest subcarrier spacing allowed for each frequency range. For example, the subcarrier spacing S1 or S2 may be 15 KHz for frequency range 1 and 60 KHz for frequency range 2. Alternatively, the subcarrier spacing S1 or S2 may be largest subcarrier spacing allowed for each frequency range. For example, the subcarrier spacing S1 or S2 may be 60 KHz for frequency range 1 and 120 KHz for frequency range 2. In these approaches, the subcarrier spacing S1 or S2 may not be dependent on the subcarrier spacing of the DL/UL BWPs or DL/UL carrier.

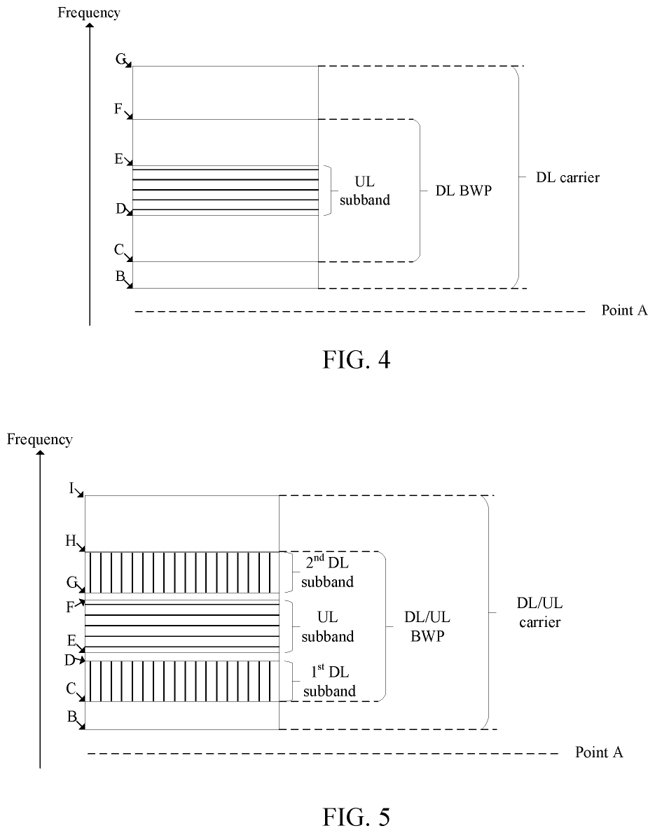

Referring to FIG. 4 as an example, the frequency resource of the UL subband is between frequency point D and frequency point E. The frequency resource of the UL subband can be configured via a starting point D and a bandwidth. The starting point D can be configured via a frequency offset relative to the starting point of DL BWP associated with the UL subband (point C) (this corresponds with the second alternative discussed above). Alternatively, the starting point D can be configured via a frequency offset relative to the starting point of the DL carrier (point B) (this corresponds with the third alternative discussed above).

### Configuration of Frequency Resources for DL Subband

In accordance with various embodiments, the starting point or middle point of the DL subband is configured as a frequency offset relative to a reference point. As such, the method may include the base station 102 indicating, to the wireless terminal device 104, and the wireless terminal device 104 receiving an indication of the starting point or the middle point of the DL subband as a frequency offset relative to a reference point.

The reference point may be defined as one of the following alternatives. The reference point may be point A, where point A serves as a common reference point for resource block grids. Point A is the same reference point for both DL and UL in TDD systems, which is convenient to determine the frequency resource for both DL subband and UL subband.

The reference point may be the starting point of the DL BWP that is associated with the DL subband. In this approach, it may be convenient to configure the DL subband within the DL BWP.

The reference point may be the starting point of the DL carrier that corresponds to the subcarrier spacing of the DL BWP that is associated with the DL subband. In this approach, it may be convenient to configure the UL subband within the DL BWP and also within the DL carrier.

The reference point may be the starting point of the UL BWP that is associated with the DL subband. In this approach, it may be convenient to configure the DL subband within the UL BWP.

The reference point may be the starting point of the UL carrier that corresponds to the subcarrier spacing of the UL BWP that is associated with the DL subband. In this approach, it may be convenient to configure the DL subband within the UL BWP and also within the UL carrier.

The reference point may be the lowest starting point of the UL carrier corresponding to all the configured subcarrier spacings of this UL carrier. It may be convenient to configure the same frequency resource for the DL subband for UL carrier for different subcarrier spacings.

The reference point may be the lowest starting point of the DL carrier corresponding to all the configured subcarrier spacings of this DL carrier. It may be convenient to configure the same frequency resource for the DL subband for DL carrier for different subcarrier spacings.

The reference point may be the lowest starting point selected from the lowest starting point of the DL carrier corresponding to all the configured subcarrier spacings of this DL carrier and the lowest starting point of the UL carrier corresponding to all the configured subcarrier spacings of this UL carrier. It may be convenient to configure the same frequency resource for the DL subband for both DL carrier and UL carrier for different subcarrier spacings.

As stated above, the starting point or middle point of the DL subband may be configured as a frequency offset relative to a reference point. The subband bandwidth (or half of the subband bandwidth) may be configured as a number of the frequency units. The frequency offset for configuring the starting point or middle point of the DL subband may correspond to a subcarrier spacing S1. The subband bandwidth for the DL subband may correspond to a subcarrier spacing S2. The subcarrier spacing S1 can be the same as or different from the subcarrier spacing S2. As such, the method may include the base station 102 indicating to the UE 104, and the UE 104 receiving an indication of the frequency offset as a first subcarrier spacing S1, and/or the subband bandwidth of the UL subband as a second subcarrier spacing S2. The method may also include the base station 102 indicating to the UE 104, and the UE 104 receiving an indication of the first subcarrier spacing S1 and the second subcarrier spacing S2 according to one of the following alternatives.

The subcarrier spacing S1 or S2 may be the subcarrier spacing of the DL BWP that is associated with the DL subband. In this approach, it may be convenient to guarantee that the frequency resource of DL subband is within the associated DL BWP.

The subcarrier spacing S1 or S2 may be the subcarrier spacing of the UL BWP that is associated with the DL subband. In this approach, it may be convenient to guarantee that the frequency resource of dL subband is within the associated UL BWP.

The subcarrier spacing S1 or S2 may be the smallest subcarrier spacing of all the UL BWPs for the UL carrier. In this approach, it may be convenient to configure the same frequency resource of the DL subband for all the UL BWPs.

The subcarrier spacing S1 or S2 may be the smallest subcarrier spacing of all the DL BWPs for the DL carrier. In this approach, it may be convenient to configure the same frequency resource of the DL subband for all the DL BWPs.

The subcarrier spacing S1 or S2 may be the largest subcarrier spacing of all the UL BWPs for the UL carrier. In this approach, it may be convenient to configure the same frequency resource of the DL subband for all the UL BWPs.

The subcarrier spacing S1 or S2 may be the largest subcarrier spacing of all the DL BWPs for the DL carrier. In this approach, it may be convenient to configure the same frequency resource of the DL subband for all the DL BWPs.

The subcarrier spacing S1 or S2 may be the smallest subcarrier spacing configured for the UL carrier. In this approach, it may be convenient to configure the same frequency resource of the DL subband for all the UL BWPs.

The subcarrier spacing S1 or S2 may be the smallest subcarrier spacing configured for the DL carrier. In this approach, it may be convenient to configure the same frequency resource of the DL subband for all the DL BWPs.

The subcarrier spacing S1 or S2 may be the smallest subcarrier spacing of all the UL BWPs for the UL carrier and all the DL BWPs for the DL carrier. Alternatively, the subcarrier spacing S1 or S2 may be the smallest subcarrier spacing configured for the UL carrier and DL carrier. In these approaches, it may be convenient to configure the same frequency resource of DL subband for all the DL BWPs and for all the UL BWPs.

The subcarrier spacing S1 or S2 may be the smallest subcarrier spacing allowed for each frequency range. For example, the subcarrier spacing S1 or S2 may be 15 KHz for frequency range 1 and 60 KHz for frequency range 2. Alternatively, the subcarrier spacing S1 or S2 may be largest subcarrier spacing allowed for each frequency range. For example, the subcarrier spacing S1 or S2 may be 60 KHz for frequency range 1 and 120 KHz for frequency range 2. In these approaches, the subcarrier spacing S1 or S2 may not be dependent on the subcarrier spacing of the DL/UL BWPs or DL/UL carrier.

FIG. 5 illustrates an example DUD subband pattern. In this example, the frequency resource of the first DL subband is between frequency point C and frequency point D. The frequency resource of the second DL subband is between frequency point G and frequency point H. The frequency resource of the first DL subband can be configured via a starting point C and a bandwidth. The starting point C can be configured via a frequency offset relative to the starting point of DL BWP associated with the UL subband (point C) (this corresponds with the second alternative discussed above). However, typically the starting point of the DL BWP and the starting point of the DL subband may be aligned. In this case, the frequency offset for DL subband may not need to be indicated by the base station 102 to the UE 104.

### Reduction of Overhead for Subband Configuration

In various embodiments, the overhead (e.g., overhead transmission) may be reduced when configuring UL subband, DL subband, and/or guard band frequency resources. To further clarify the overhead reduction of the subband configuration, the following parameters are assumed. The starting point and bandwidth of the DL BWP associated with the subband is S_{DL-BWP} and B_{DL-BWP}, respectively. Thus, the ending point of the DL BWP is E_{DL-BWP}, where E_{DL-BWP}=S_{DL-BWP}+B_{DL-BWP}. Similarly, the starting point and bandwidth of the UL BWP associated with the subband is S_{UL-BWP} and B_{UL-BWP}, respectively. Thus, the ending point of the UL BWP is E_{UL-BWP}, where E_{UL-BWP}=S_{UL-BWP}+B_{UL-BWP}. The middle point of the DL BWP with the subband is M_{DL-BWP}.

The starting point and bandwidth of the DL carrier is S_{DL-CC} and B_{DL-CC}, respectively. Thus, the ending point of the DL carrier is E_{DL-CC}, where E_{DL-CC}=S_{DL-CC}+B_{DL-CC}. Similarly, the starting point and bandwidth of the UL carrier is S_{UL-CC} and B_{UL-CC}, respectively. Thus, the ending point of the UL carrier is E_{UL-CC}, where E_{UL-CC}=S_{UL-CC}+B_{UL-CC}.

The starting point and ending point of the BWP are the two edges of the BWP. Similarly, the starting point and ending point of the carrier are the two edges of the carrier.

In various embodiments, the methods may include the base station 102 indicating to the wireless terminal device 104, and the wireless terminal device 104 receiving an indication of at least one of an Uplink-Downlink (UD) subband pattern, a Downlink-Uplink (DU) subband pattern, or a Downlink-Uplink-Downlink (DUD) subband pattern. This indication may be express or implicit, as discussed in the various alternatives below.

In a first example, the method may include the base station 102 indicating to the wireless terminal device 104, and the wireless terminal device 104 receiving an indication of the UD, DU, or DUD subband pattern via Radio Resource Control (RRC) signaling. In this approach, the base station 102 expressly indicates the subband pattern, for example, RRC signaling is utilized to indicate the detailed subband pattern to the UE. However, in the following examples, the UE 104 may infer the subband pattern based on other information received from the base station 102.

In a second example, the method may include the base station 102 indicating to the wireless terminal device 104, and the wireless terminal device 104 receiving an indication of the DUD subband pattern by indicating or receiving an indication of a same middle point for the UL subband and a DL BWP. In this example, the base station 102 indicates the frequency resource allocation for the UL subband and the DL (or UL) BWP, and the UE 104 infers the DUD subband pattern from this received information. This has the effect of reducing the RRC signaling overhead.

In a third example, the method may include the base station 102 indicating to the wireless terminal device 104, and the wireless terminal device 104 receiving an indication of the DU subband pattern by indicating or receiving an indication of a same starting point for the UL subband and a DL BWP. In this example, the base station 102 indicates the frequency resource allocation for the UL subband and the DL (or UL) BWP, and the UE 104 infers the DU subband pattern from this received information. This again has the effect of reducing the RRC signaling overhead.

In a fourth example, the method may include the base station 102 indicating to the wireless terminal device 104, and the wireless terminal device 104 receiving an indication of the UD subband pattern by indicating or receiving an indication of a same starting point for the DL subband and a DL BWP. In this example, the base station 102 indicates the frequency resource allocation for the DL subband and the DL (or UL) BWP, and the UE 104 infers the UD subband pattern from this received information. This again has the effect of reducing the RRC signaling overhead.

In other examples, the base station 102 can also indicate the DUD, DU, or UD subband pattern to the UE 104 via at least one of the following alternatives. The base station 102 may indicate the DUD subband pattern to the UE 104 via indicating the same middle point for the UL subband and UL BWP to the UE 104. The base station 102 may indicate the DU subband pattern to the UE 104 via indicating the same starting point for the UL subband and UL BWP to the UE 104. The base station 102 may indicate the DU subband pattern to the UE 104 via indicating the same ending point for the DL subband and DL BWP to the UE 104. The base station 102 may indicate the DU subband pattern to the UE 104 via indicating the same ending point for the DL subband and UL BWP to the UE 104. The base station 102 may indicate the UD subband pattern to the UE 104 via indicating the same starting point for the DL subband and UL BWP to the UE 104. The base station 102 may indicate the UD subband pattern to the UE 104 via indicating the same ending point for the UL subband and DL BWP to the UE 104. The base station 102 may indicate the UD subband pattern to the UE 104 via indicating the same ending point for the UL subband and UL BWP to the UE 104.

In various embodiments, for the case of a DUD subband pattern, the method may include the base station 102 indicating, to the wireless terminal device 104, and the wireless terminal device 104 receiving an indication of the DUD subband pattern (directly or indirectly) and a DL subband bandwidth (B_{DL-subband}). In this instance, a starting point of a first DL subband of the DUD subband pattern may be a starting point of the DL BWP (S_{DL-BWP}), and an ending point of the first DL subband may be S_{DL-BWP}+B_{DL-subband}. Similarly, an ending point of a second DL subband of the DUD subband pattern may be an ending point of the DL BWP (E_{DL-BWP}), and a starting point of the second DL subband may be E_{DL-BWP}−B_{DL-subband}. Alternatively, the starting point of the second DL subband could also be considered as E_{DL-BWP}, and the ending point of the second DL subband could be E_{DL-BWP}−B_{DL-subband}. In various approaches, the method may include the UE 104 determining these starting and ending points according to these stated relationships.

In various embodiments, for the case of a DUD subband pattern, the method may include the base station 102 indicating, to the wireless terminal device 104, and the wireless terminal device 104 receiving an indication of the DUD subband pattern (directly or indirectly) and a DL subband bandwidth (B_{DL-subband}). In this example, a middle point of the UL subband may be a middle point of the DL BWP (M_{DL-BWP}). The starting point of the UL subband may then be M_{DL-BWP}−B_{UL-subband}/2, and an ending point of the UL subband may be M_{DL-BWP}+B_{UL-subband}/2. Again, the method may include the UE 104 determining these starting and ending points according to these stated relationships.

In various embodiments, for the case of a DU or UD subband pattern, the method may include the base station 102 indicating, to the wireless terminal device 104, and the wireless terminal device 104 receiving an indication of the DU or UD subband pattern (directly or indirectly). In a first alternative, a starting point of the DL subband and the UL subband are aligned with a starting point of the DL BWP (S_{DL-BWP}) and an ending point of the DL BWP (E_{DL-BWP}), respectively, and the UL subband has a bandwidth (B_{UL-subband}), and the DL subband has a bandwidth (B_{DL-subband}). Then, the starting point of the DL subband may be S_{DL-BWP}, an ending point of the DL subband may be S_{DL-BWP}+B_{DL-subband}, the starting point of the UL subband may be E_{DL-BWP}, and an ending point of the UL subband may be E_{DL-BWP}−B_{UL-subband}. Again, the method may include the UE 104 determining these starting and ending points according to these stated relationships.

In a second alternative, a starting point of the DL subband and the UL subband are aligned with an ending point of the DL BWP (E_{DL-BWP}) and a starting point of the DL BWP (S_{DL-BWP}), respectively, and the UL subband has a bandwidth (B_{UL-subband}), and the DL subband has a bandwidth (B_{DL-subband}). Then, the starting point of the UL subband may be S_{DL-BWP}, an ending point of the UL subband may be S_{DL-BWP}+B_{UL-subband}, the starting point of the DL subband may be E_{DL-BWP}, and an ending point of the DL subband may be E_{DL-BWP}−B_{DL-subband}. Again, the method may include the UE 104 determining these starting and ending points according to these stated relationships.

In various embodiments, for the case of a DU or UD subband pattern, the method may include the base station 102 indicating to the wireless terminal device 104, and the wireless terminal device 104 receiving an indication of the DU or UD subband pattern (directly or indirectly), a bandwidth of a guard band (B_{Guard}), and a bandwidth of the UL subband (B_{UL-subband}). The DL BWP has a starting point (S_{DL-BWP}) and an ending point (E_{DL-BWP}). Then, for the UD subband pattern, a starting point of the DL subband may be aligned with a starting point of the DL BWP (S_{DL-BWP}), and an ending point of the DL subband may be E_{DL-BWP}−B_{UL-subband}−B_{Guard}. Similarly, for the DU subband pattern, the starting point of the DL subband may be S_{DL-BWP}+B_{UL-subband}+B_{Guard}, and the ending point of the DL subband may be aligned with the ending point of the DL BWP (E_{DL-BWP}). Again, the method may include the UE 104 determining these starting and ending points according to these stated relationships.

In various embodiments, for the case of a DU or UD subband pattern, the method may include the base station 102 indicating to the wireless terminal device 104, and the wireless terminal device 104 receiving an indication of the DU or UD subband pattern (directly or indirectly), a bandwidth of a guard band (B_{Guard}), and a bandwidth of the DL subband (B_{DL-subband}). The DL BWP has a starting point (S_{DL-BWP}) and an ending point (E_{DL-BWP}). Then, for the DU subband pattern, a starting point of the UL subband may be aligned with a starting point of the DL BWP (S_{DL-BWP}), and an ending point of the UL subband may be E_{DL-BWP}−B_{DL-subband}−B_{Guard}. Similarly, for the UD subband pattern, the starting point of the UL subband may be S_{DL-BWP}+B_{DL-subband}+B_{Guard}, and the ending point of the UL subband may be aligned with the ending point of the DL BWP (E_{DL-BWP}). Again, the method may include the UE 104 determining these starting and ending points according to these stated relationships.

In some embodiments, the base station 102 may indicate two bandwidths of the guard band (B_{Guard1} ∧B_{Guard2}) to the UE 104. This implies the DUD subband pattern. In this case, the size of the guard band between the first DL subband and the UL subband may be different from the size of the guard band between the second DL subband and the UL subband. In such an instance, the starting point of the first DL subband may be S_{DL-BWP}, and the ending point of the first DL subband may be S_{DL-BWP}+B_{DL-subband}. Similarly, the starting point of the second DL subband may be S_{DL-BWP}+B_{DL-subband}+B_{Guard1}+B_{UL-subband}+B_{Guard2}, and the ending point of the second DL subband may be E_{DL-BWP}.

### Guard Band Configuration

In various embodiments, the base station 102 may configure the bandwidth of the guard band (B_{Guard}) to the UE 104. With reference to FIG. 5 as an example, the frequency resource for one guard band is between frequency point D and E. In one example, for a DUD subband pattern, the method may include the base station 102 indicating to the wireless terminal device 104, and the wireless terminal device 104 receiving an indication of the DUD subband pattern (directly or indirectly), a bandwidth of a guard band (B_{Guard}), and a bandwidth of the DL subband (B_{DL-subband}). The DL BWP may have a starting point (S_{DL-BWP}) and an ending point (E_{DL-BWP}). Then, the starting point of a first guard band may be S_{DL-BWP}+B_{DL-subband}, and an ending point of the first guard band may be S_{DL-BWP}+B_{DL-subband}+B_{Guard}. In some examples, the ending point of the first guard band may be aligned with the starting point of the UL subband, and/or the starting point of the first guard band may be aligned with the ending point of the first DL subband. The starting point of a second guard band may be E_{DL-BWP}−B_{DL-subband}−B_{Guard}, and an ending point of the second guard band is E_{DL-BWP}−B_{DL-subband}. In some examples, the ending point of the second guard band is aligned with the ending point of the second DL subband, and/or the starting point of the second guard band is aligned with the ending point of the UL subband. Again, the method may include the UE 104 determining these starting and ending points according to these stated relationships.

In another example, for a DU or UD subband pattern, the method may include the base station 102 indicating to the wireless terminal device 104, and the wireless terminal device 104 receiving an indication of indicating, to the wireless terminal device, one of the DU or UD subband patterns, a bandwidth of a guard band (B_{Guard}), and a bandwidth of the DL subband (B_{DL-subband}). The DL BWP may have a starting point (S_{DL-BWP}) and an ending point (E_{DL-BWP}). Then, for the UD subband pattern, a starting point of the guard band may be S_{DL-BWP}+B_{DL-subband}, and an ending point of the guard band may be S_{DL-BWP}+B_{DL-subband}+B_{Guard}. In some examples, the ending point of the guard band may be aligned with the starting point of the UL subband, and/or the starting point of the guard band may be aligned with the ending point of the DL subband. Also, for the DU subband pattern, the starting point of the guard band may be S_{DL-BWP}+B_{UL-subband}, and the ending point of the guard band may be S_{DL-BWP}+B_{UL-subband}+B_{Guard}. In some examples, the ending point of the guard band may be aligned with the starting point of the DL subband, and/or the starting point of the guard band may be aligned with the ending point of the UL subband. Again, the method may include the UE 104 determining these starting and ending points according to these stated relationships.

In various embodiments, the bandwidth of the guard band corresponds to a subcarrier spacing S. The subcarrier spacing S may be determined as one of the following alternatives. The subcarrier spacing S may be the subcarrier spacing of the DL BWP that is associated with the DL subband. The subcarrier spacing S may be the subcarrier spacing of the UL BWP that is associated with the UL subband. The subcarrier spacing S may be the smallest subcarrier spacing of all the UL BWPs for the UL carrier. The subcarrier spacing S may be the smallest subcarrier spacing of all the DL BWPs for the DL carrier. The subcarrier spacing S may be the largest subcarrier spacing of all the UL BWPs for the UL carrier. The subcarrier spacing S may be the largest subcarrier spacing of all the DL BWPs for the DL carrier. The subcarrier spacing S may be the smallest subcarrier spacing configured for the UL carrier. The subcarrier spacing S may be the smallest subcarrier spacing configured for the DL carrier. The subcarrier spacing S may be the smallest subcarrier spacing of all the UL BWPs for the UL carrier and all the DL BWPs for the DL carrier. The subcarrier spacing S may be the smallest subcarrier spacing configured for the UL carrier and DL carrier. The subcarrier spacing S may be the smallest subcarrier spacing allowed for each frequency range. For example, the subcarrier spacing S may be 15 KHz for frequency range 1 and 60 KHz for frequency range 2. The subcarrier spacing S may be the largest subcarrier spacing allowed for each frequency range. For example, the subcarrier spacing S may be 60 KHz for frequency range 1 and 120 KHz for frequency range 2. The reasons to apply the above variations may be similar to the corresponding alternatives for subcarrier spacings S1 and S2 discussed above.

The subcarrier spacing S may be the same as the subcarrier spacing of the DL subband. It may be convenient to schedule DL transmission in the guard band if this is allowed due to the same subcarrier spacing as the DL subband. The subcarrier spacing S may be the same as the subcarrier spacing of the UL subband. It may be convenient to schedule UL transmission in the guard band if this is allowed due to the same subcarrier spacing as the UL subband. The subcarrier spacing S may be a smaller one of the subcarrier spacing of the DL subband and the subcarrier spacing of the UL subband. The subcarrier spacing S may be a larger one of the subcarrier spacing of the DL subband and the subcarrier spacing of the UL subband. It may be convenient to schedule DL or UL transmission in the guard band if this is allowed. Normally, the UE 104 is not required to transmit or receive in the guard band. However, in some cases, the UE 104 may be allowed to transmit or receive reference signal in the guard band if it does not incur any interference to other transmissions.

### Configuration Restrictions

In various embodiments, the base station 102 may configure the frequency resource of the subband such that the subband meets at least one of the following conditions. The frequency resource of UL subband may be within the DL BWP that is associated with the UL subband. The frequency resource of UL subband may be within the UL BWP that is associated with the UL subband. The frequency resource of UL subband may be within the DL BWP that is associated with the UL subband, and may be within the UL BWP that is associated with the DL BWP. The frequency resource of DL subband may be within the DL BWP that is associated with the DL subband. The frequency resource of DL subband may be within the DL BWP that is associated with the DL subband, and may be within the UL BWP that is associated with the DL BWP. In some approaches, the base station 102 may configure the frequency resource of the subband such that the starting point of the DL subband is aligned with the starting point of the DL BWP or aligned with the ending point of the DL BWP. In some approaches, the base station 102 may configure the frequency resource of the subband such that the UL subband meets at least one of the following conditions. The starting point of the UL subband may be aligned with the starting point of the DL BWP. The starting point of the UL subband may be aligned with the ending point of the DL BWP. The middle point of the UL subband may be aligned with the middle point of the DL BWP. The middle point of the UL subband may be aligned with the middle point of the UL BWP. The middle point of the UL subband may be aligned with the middle point of the DL BWP and aligned with the middle point of the UL BWP. Referring again to FIG. 5 as an example, the DL BWP has the same frequency resource as the UL BWP. Similarly, in this example, the DL carrier and UL carrier have the same frequency resource. The DL and UL will be assigned with different time slots or symbols. As shown in the FIG. 5, the frequency resource of UL subband is within the DL BWP that is associated with the UL subband, and is within the UL BWP that is associated with the DL BWP. This is an example of the condition stated above that the frequency resource of UL subband may be within the DL BWP that is associated with the UL subband, and may be within the UL BWP that is associated with the DL BWP.

### BWP Associated With the Subband

In various embodiments, if DL BWP is associated with the DL subband, then the DL subband can be applied or activated within this DL BWP. The DL BWP may be associated with the DL subband if at least one of the following is satisfied (or the DL subband is associated with the DL BWP if at least one of the following is satisfied). The frequency resource of the DL subband is within the DL BWP. The starting point of the DL subband is aligned with the starting point of the DL BWP or aligned with the ending point of the DL BWP. The ending point of the DL subband is aligned with the ending point of the DL BWP. Alternatively, the base station indicates the association between DL BWP and DL subband to the UE via RRC signaling.

In another example, the UL BWP is associated with the UL subband if at least one of the following is satisfied (or the UL subband is associated with the UL BWP if at least one of the following is satisfied). The frequency resource of the UL subband is within the UL BWP. The starting point of the UL subband is aligned with the starting point of the UL BWP or aligned with the ending point of the UL BWP. The ending point of the UL subband is aligned with the ending point of the UL BWP. The middle point of the UL subband is aligned with the middle point of the UL BWP. Alternatively, the base station indicates the association between UL BWP and UL subband to the UE via RRC signaling.

In another example, the DL BWP is associated with the UL subband if at least one of the following is satisfied (or the DL subband is associated with the DL BWP if at least one of the following is satisfied). The frequency resource of the UL subband is within the DL BWP. The starting point of the UL subband is aligned with the starting point of the UL BWP or aligned with the ending point of the UL BWP. The ending point of the UL subband is aligned with the ending point of the DL BWP. The middle point of the UL subband is aligned with the middle point of the DL BWP. Alternatively, the base station indicates the association between DL BWP and UL subband to the UE via RRC signaling.

In another example, the UL BWP is associated with the DL subband if at least one of the following is satisfied (or the DL subband is associated with the DL BWP if at least one of the following is satisfied). The frequency resource of the DL subband is within the UL BWP. The starting point of the DL subband is aligned with the starting point of the UL BWP or aligned with the ending point of the UL BWP. The ending point of the DL subband is aligned with the ending point of the UL BWP. The middle point of the DL subband is aligned with the middle point of the UL BWP. Alternatively, the base station indicates the association between UL BWP and DL subband to the UE via RRC signaling.

### Numerology of the Subband

In various embodiments, the numerology of the subband may be the same as the associated BWP, in other words, the subcarrier spacing of the subband may be the same as the associated BWP. For example, if the UL subband is associated with the DL BWP and the subcarrier spacing of the DL BWP is 30 KHz, then the subcarrier spacing of the UL subband is 30 KHz.

Each numerology may correspond to one subcarrier spacing. For example, numerology 0, 1, 2 and 3 may correspond to 15 KHz, 30 KHz, 60 KHz, and 120 KHz, respectively.

If the subband bandwidth is configured corresponding to a numerology u1 and the numerology of the subband is u2, the relationship between the physical resource block (PRB) index (Iₛₜₐᵣₜ) and common resource block (CRB) index (I_{CRB}) is I_{CRB}=Iₛₜₐᵣₜ+└I_{PRB}·2^{u1-u2}┘, where Iₛₜₐᵣₜ is the starting point of the subband. Since both I_{CRB} and Iₛₜₐᵣₜ are integer numbers, the equation is the same as I_{CRB}=└Iₛₜₐᵣₜ+I_{PRB}·2^{u1-u2}. “└ ┘” refers to round down operation.

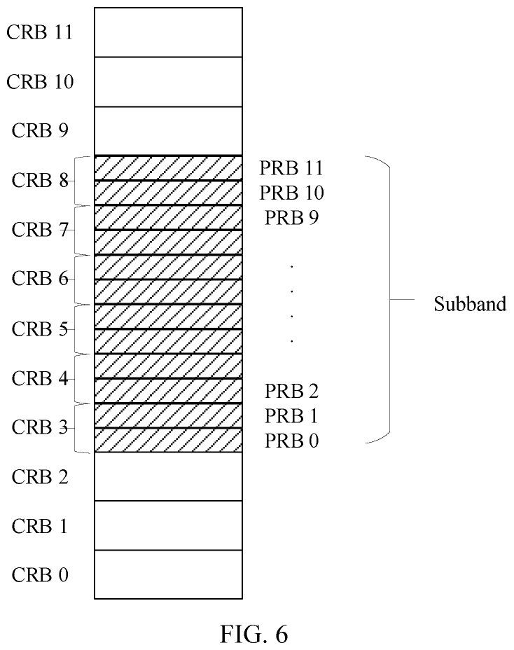

For example, as shown in FIG. 6, the subband bandwidth is configured corresponding to a numerology 0 and the numerology of the subband is 1 (because the associated BWP of the subband is with 30 KHz), Iₛₜₐᵣₜ=3, for the PRB 2, it resides in the CRB I_{CRB}=3+└2×2⁻¹┘=4.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a wireless access network node comprising:
configuring, to a wireless terminal device, at least one frequency resource for at least one subband,
wherein the at least one subband comprises at least one of a Downlink (DL) subband, or an Uplink (UL) subband.

2. The method according to claim 1, comprising:
indicating, to the wireless terminal device, a starting point and a subband bandwidth of the at least one subband.

3-5. (canceled)

6. The method according to claim 1, wherein the at least one subband is an UL subband, the method comprising:
indicating, to the wireless terminal device, a starting point of the UL subband, wherein the starting point is positioned at a frequency offset relative to a reference point.

7. The method according to claim 6, wherein the reference point is defined as following:
a starting point of an UL carrier that corresponds to a subcarrier spacing.

8. The method according to claim 6, comprising:
indicating, to the wireless terminal device, the frequency offset corresponding to a first subcarrier spacing S1; or
indicating, to the wireless terminal device, the subband bandwidth of the UL subband corresponding to a second subcarrier spacing S2.

9. (canceled)

10. The method according to claim 1, wherein the at least one subband is a DL subband, the method comprising:
indicating, to the wireless terminal device, a starting point of the DL subband, wherein the starting point is positioned at a frequency offset relative to a reference point.

11. The method according to claim 10, wherein the reference point is defined as following:
a starting point of a DL carrier that corresponds to a subcarrier spacing.

12. The method according to claim 10, comprising:
indicating, to the wireless terminal device, the frequency offset corresponding to a first subcarrier spacing S1; or
indicating, to the wireless terminal device, the subband bandwidth of the DL subband corresponding to a second subcarrier spacing S2.

13-32. (canceled)

33. The method according to claim 2, wherein the subband bandwidth comprises a number of frequency units for the subband.

34. A method performed by a wireless terminal device comprising:
receiving, from a wireless access network node, a configuration of at least one frequency resource for at least one subband,
wherein the at least one subband comprises at least one of a Downlink (DL) subband, or an Uplink (UL) subband

35. The method according to claim 34, comprising:
receiving, from the wireless access network node, an indication of a starting point and a subband bandwidth of the at least one subband.

36-38. (canceled)

39. The method according to claim 34, wherein the at least one subband is an UL subband, the method comprising:
receiving, from the wireless access network node, an indication of a starting point of the UL subband, wherein the starting point is positioned at a frequency offset relative to a reference point.

40. The method according to claim 39, wherein the reference point is defined as following:
a starting point of an UL carrier that corresponds to a subcarrier spacing.

41. The method according to claim 39, comprising:
receiving, from the wireless access network node, an indication of the frequency offset corresponding to a first subcarrier spacing S1; or
receiving, from the wireless access network node, an indication of the subband bandwidth of the UL subband corresponding to a second subcarrier spacing S2.

42. (canceled)

43. The method according to claim 34, wherein the at least one subband is a DL subband, the method comprising:
receiving, from the wireless access network node, an indication of a starting point of the DL subband, wherein the starting point is positioned at a frequency offset relative to a reference point.

44. The method according to claim 43, wherein the reference point is defined as following:
a starting point of a DL carrier that corresponds to a subcarrier spacing.

45. The method according to claim 43, comprising:
receiving, from the wireless access network node, an indication of the frequency offset corresponding to a first subcarrier spacing S1; or
receiving, from the wireless access network node, an indication of the subband bandwidth of the DL subband corresponding to a second subcarrier spacing S2.

46-65. (canceled)

66. The method according to claim 35, wherein the subband bandwidth comprises a number of frequency units for the subband.

67-68. (canceled)

69. The method according to claim 41, wherein the first subcarrier spacing S1 is the same as the second subcarrier spacing S2.

70. A wireless device comprising a memory for storing computer instructions and a processor in communication with the memory, wherein, when the processor executes the computer instructions, the processor is configured to cause the wireless device to:
receive, from a wireless access network node, an indication of at least one frequency resource for at least one subband,
wherein the at least one subband comprises at least one of a Downlink (DL) subband, or an Uplink (UL) subband.
